(19) United States
(12) Patent Application Publication
(10) Pub. No.: US 2026/0025891 A1
(43) Pub. Date: Jan. 22, 2026

(54) INDEPENDENT AND SEPARATE CONTROL CIRCUIT

(71) Applicant: Shenzhen Linktop IOT Co., Ltd, Shenzhen (CN)

(72) Inventor: Peipei Hu, Shenzhen (CN)

(21) Appl. No.: 19/274,538

(22) Filed: Jul. 19, 2025

(30) Foreign Application Priority Data
May 13, 2025 (CN) 202520932578.4

(51) Int. Cl. H05B 45/46

(52) U.S. Cl. CPC H05B 45/46

(57) ABSTRACT

Disclosed is an independent and separate control circuit, including a first control chip, a second control chip, a first MOS transistor, a second MOS transistor, a third MOS transistor, a fourth MOS transistor, a first triode, a second triode, a main lamp body bright white light string, a main lamp body warm white light string, a base bright white light string and a base warm white light string. Bright white light and warm white light at different positions of a lamp may be separately controlled by means of the circuit provided by the disclosure, grouped and independent control is realized, and overall light control is integrated on one circuit, such that the circuit cost may be effectively reduced, and the circuit may be better applied to an external controller.

### BACKGROUND OF THE INVENTION

### Technical Field

The disclosure relates to the technical field of electronic circuits, in particular to an independent and separate control circuit.

### Description of Related Art

With the development and progress of the society, smart lamp products become increasingly popular, and users put higher requirements for smart control products, and under the condition of satisfying functional requirements, the products are required to have high cost performance and be easy to maintain after sales. In view of this, a controller is arranged outside a lamp for the convenience of operation and replacement. If the controller is arranged inside the lamp, when the controller breaks down, the whole lamp has to be changed because it is inconvenient to change and maintain the controller separately, leading to a higher cost. Due to the shape of the lamp, some portions of the lamp emit light upwards while some portions of the lamp emit light downwards, and the same portion of the lamp may have different color temperatures (i.e., the same portion of the lamp may emit both bright white light and warm white light), so several separate control circuits are configured to realize control of the lamp; and because the controller is arranged outside the lamp, there will be many wires between a lamp body and the controller, and the wires are relatively long, leading to an increase in cost, complex processing of the wires, and other impacts.

### BRIEF SUMMARY OF THE INVENTION

In view of the defects in the prior art, the objective of the disclosure is to provide an independent and separate control circuit capable of separately controlling two light-emitting circuits at the same time.

To fulfill the above objective, the disclosure adopts the following technical solution:
An independent and separate control circuit includes a first control chip, a second control chip, a first MOS transistor, a second MOS transistor, a third MOS transistor, a fourth MOS transistor, a first triode, a second triode, a main lamp body bright white light string, a main lamp body warm white light string, a base bright white light string and a base warm white light string;
an OUTR pin of the first control chip is accessed to a power supply by means of a second resistor and connected to a gate of the first MOS transistor, a drain of the first MOS transistor is accessed to a 5V power supply by means of a first resistor and connected to a gate of the second MOS transistor, a drain of the second MOS transistor is connected to the main lamp body warm white light string by means of a first output resistor, an OUTG pin of the first control chip is accessed to a power supply by means of a third resistor and connected to a gate of the third MOS transistor, a drain of the third MOS transistor is accessed to a 5V power supply by means of a fourth resistor and connected to a gate of the fourth MOS transistor, a drain of the fourth MOS transistor is connected to the main lamp body bright white light string by means of a second output resistor, and a source of the first MOS transistor, a source of the second MOS transistor, a source of the third MOS transistor and a source of the fourth MOS transistor are grounded;
an OUTR pin of the second control chip is connected to a base of the first triode diode by means of a fifth resistor, the base of the first triode is connected to an emitter of the first triode by means of a sixth resistor, the emitter of the first triode is connected to the base warm white light string by means of a third output resistor, an OUTG pin of the second control chip is connected to a base of the second triode by means of a seventh resistor, the base of the second triode is connected to an emitter of the second triode by means of an eight resistor, the emitter of the second triode is connected to the base bright white light string by means of a fourth output resistor, and a collector of the first triode and a collector of the second triode are grounded.

By adopting the above technical solution, bright white light and warm white light at different positions of a lamp may be separately controlled by means of the circuit provided by the disclosure, grouped and independent control is realized, and overall light control is integrated on one circuit, such that the circuit cost may be effectively reduced, and the circuit may be better applied to an external controller.

### BRIEF DESCRIPTION OF THE SEVERAL VIEWS OF THE DRAWINGS

FIG. 1 is a schematic structural diagram of a circuit according to one embodiment of the disclosure.

### DETAILED DESCRIPTION OF THE INVENTION

To better clarify the objectives, technical solutions and advantages of the disclosure, the disclosure is described in further detail below in conjunction with accompanying drawings and embodiments. It should be understood that the specific embodiments described here are merely used for explaining the disclosure rather than limiting the disclosure.

In the description of the disclosure, it should be understood that terms such as “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise” and “anticlockwise” are used to indicate directional or positional relations based on the accompanying drawings merely for the purpose of facilitating and simplifying the description of the disclosure, do not indicate or imply that devices or elements referred to must be in a specific direction or be configured and operated in a specific direction, and thus should not be construed as indicating or implying relative importance or implicitly indicating the number of technical features referred to. Therefore, a feature defined by “first” or “second” may explicitly or implicitly indicate the inclusion of one or more said features. In the description of the disclosure, “multiple” means two or more, unless otherwise expressly and specifically defined.

In the description of the disclosure, it should be noted that unless otherwise expressly stated and defined, terms “mount”, “link” and “connect” should be understood in a broad sense. For example, “connect” may refer to fixed connection, detachable connection or integrated connection; mechanical connection or electrical connection; direct connection, indirect connection by means of an intermediate medium, or internal connection or interaction between two elements. Those ordinarily skilled in the art may appreciate the specific meaning of these terms in the disclosure according to specific circumstances.

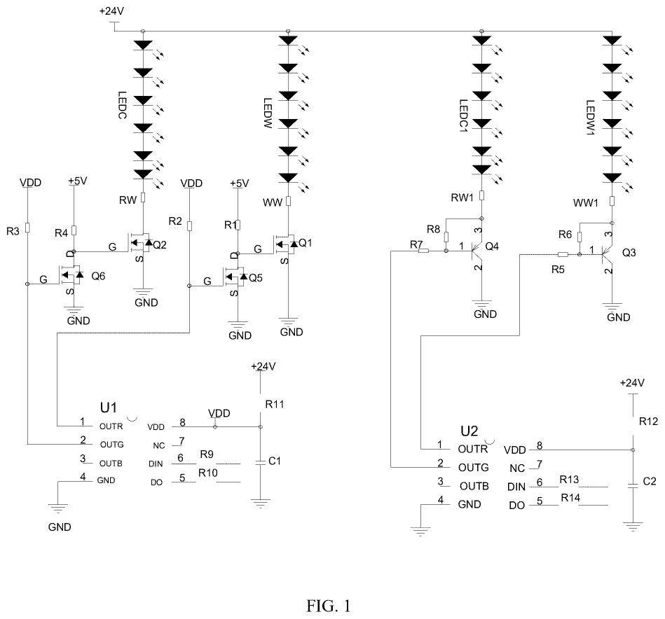

As shown in FIG. 1, this embodiment provides an independent and separate control circuit, including a first control chip U1, a second control chip U2, a first MOS transistor Q5, a second MOS transistor Q1, a third MOS transistor Q6, a fourth MOS transistor Q2, a first triode Q3, a second triode Q4, a main lamp body bright white light string LEDC, a main lamp body warm white light string LEDW, a base bright white light string LEDC1 and a base warm white light string LEDW1;

an OUTR pin of the first control chip is accessed to a power supply by means of a second resistor and connected to a gate of the first MOS transistor, a drain of the first MOS transistor is accessed to a 5V power supply by means of a first resistor and connected to a gate of the second MOS transistor, a drain of the second MOS transistor is connected to the main lamp body warm white light string by means of a first output resistor, an OUTG pin of the first control chip is accessed to a power supply by means of a third resistor and connected to a gate of the third MOS transistor, a drain of the third MOS transistor is accessed to a 5V power supply and connected to a gate of the fourth MOS transistor, a drain of the fourth MOS transistor is connected to the main lamp body bright white light string by means of a second output resistor, and a source of the first MOS transistor, a source of the second MOS transistor, a source of the third MOS transistor and a source of the fourth MOS transistor are grounded;

an OUTR pin of the second control chip is connected to a base of the first triode by means of a fifth resistor, the base of the first triode is connected to an emitter of the first triode by means of a sixth resistor, the emitter of the first triode is connected to the base warm white light string by means of a third output resistor, an OUTR pin of the second control chip is connected to a base of the second triode by means of a seventh resistor, the base of the second triode is connected to an emitter of the second triode by means of an eight resistor, the emitter of the second triode is connected to the base bright white light string by means of a fourth output resistor, and a collector of the first triode and a collector of the second triode are grounded.

Wherein, the first control chip and the second control chip are SW2811 chips.

In specific operation of the independent and separate control circuit in this embodiment:
when a warm white light circuit of a main lamp body is controlled, a signal DIN terminal of a sixth pin of the first control chip U1 receives data transmitted from a controller, and a data latch in the first control chip U1 generates a duty cycle control signal at a first (OUTR) control terminal of the first control chip U1 according to the received data; when receiving a low-level RESET code, the first control chip U1 outputs a PWM data pulse width received just now to the OUTR pin; when the OUTR pin is at a low level, VDD is connected to the OUTR pin from the second resistor R2, at this moment, the gate of the first MOS transistor Q5 is at a low level, and the first MOS transistor Q5 is turned off; a 5V voltage reaches the gate of the second MOS transistor Q1 by means of the first resistor R1, the second MOS transistor Q1 is turned on, a 24V voltage reaches the first output resistor WW by means of the main lamp body warm white light string LEDW and is then connected to the ground by means of the second MOS transistor Q1 to form a loop, a current passes through compound semiconductors (i.e., lamp beads), and by means of the combination of electrons and holes, surplus energy is released in the form of light to fulfill a light-emitting effect, and at this moment, warm light is emitted; VDD is connected to the OUTR pin from the second resistor R2, at this moment, the gate of the first MOS transistor Q5 is at a high level, and the MOS transistor is turned on; a 5V voltage reaches the first MOS transistor Q5 by means of the first resistor R1 and is then connected to the ground to form a loop; because the first MOS transistor Q5 is turned on, the gate of the second MOS transistor Q1 is at a low level, the second MOS transistor Q1 is in an off state, a 24V voltage reaches the first output resistor WW by means of the main lamp body warm white light string LEDW and will not be connected to the ground by means of the second MOS transistor Q1, such that a loop will not be formed, and the warm light is cut off;
similarly, when a bright white circuit of the main lamp body is controlled, the DIN terminal of the sixth pin of the first control chip U1 receives data transmitted from the controller, and the data latch in the chip generates a duty cycle control signal at a second (OUTG) control terminal of the first control chip U1 according to the received data; when receiving a low-level RESET code, the first control chip U1 outputs a PWM data pulse width received just now to the OUTG pin; when the OUTG pin is at a low level, VDD is connected to the OUTG pin from the third resistor R3, at this moment, the gate of the third MOS transistor Q6 is at a low level, and the third MOS transistor Q6 is turned off; a 5V voltage reaches the gate of the fourth MOS transistor Q2 by means of the fourth resistor R4, the fourth MOS transistor Q2 is turned on, a 24V voltage reaches the second output resistor RW by means of the main lamp body bright white light string LEDC and is then connected to the ground by means of the fourth MOS transistor Q2 to form a loop, a current passes through the compound semiconductors (i.e., lamp beads), and by means of the combination of electrons and holes, surplus energy is released in the form of light to fulfill a light-emitting effect, and at this moment, white light is emitted; when the OUTG pin is at a high level, VDD is connected to the OUTG pin from the third resistor R3, at this moment, the gate of the third MOS transistor Q6 is at a high level, and the third MOS transistor Q6 is turned on; a 5V voltage reaches the third MOS transistor Q6 by means of the third resistor R3 and is then connected to the ground to form a loop; because the third MOS transistor Q6 is turned on, the gate of the fourth MOS transistor Q2 is at a low level, the fourth MOS transistor Q2 is in an off state, a 24V voltage reaches the second output resistor RW by means of the lamp beads and will not be connected to the ground by means of the fourth MOS transistor Q2, such that a loop will not be formed, and the white light is cut off. In this way, grouped and independent control of light of the main lamp body is realized.

As for independent and separate control of white light of a base, when a warm white light circuit of the base is controlled, a DIN terminal of a sixth pin of the second control chip U2 receives data transmitted from the controller, and a data latch in the second control chip U2 generates a duty cycle control signal at a first (OUTR) control terminal of the second control chip U2; when receiving a low-level RESET code, the second control chip U2 outputs a PWM data pulse width received just now to the OUTR pin; when the OUTR pin is at a low level, the fifth resistor R5 is connected to the base of the first triode Q3; because the first triode Q3 is a P-type triode, the base of the first triode Q3 is at a low level at this moment, and the first triode Q3 is turned on; a 24V voltage reaches the third output resistor WW1 by means of the base warm white light string LEDW1 and is then connected to the ground by means of the first triode Q3, a current passes through compound semiconductors (i.e., lamp beads), and by means of the combination of electrons and holes, surplus energy is released in the form of light to fulfill a light-emitting effect, and at this moment, warm light is emitted from the base; when the OUTR pin is at a high level, the emitter and the base of the first triode Q3 are connected by means of the sixth resistor R6, the base of the first triode Q3 is at a high level, and at this moment, the first triode Q3 is not turned on; a 24V voltage reaches the third output resistor WW1 by means of the base warm white light string LEDW1 and will not be connected to the ground by means of the first triode Q3, such that a loop will not be formed, and the warm light is cut off;

when a bright white light circuit of the base is controlled, the DIN terminal of the sixth pin of the second control chip U2 receives data transmitted from the controller, and the data latch in the chip generates a duty cycle signal at a first (OUTG) control terminal of the chip; when receiving a low-level RESET code, the chip outputs a PWM data pulse width received just now to the OUTG pin; when the OUTG pin is at a low level, the seventh resistor R7 is connected to the base of the second triode Q4; because the second triode Q4 is a P-type triode, the base of the second triode Q4 is at a low level at this moment, and the second triode Q4 is turned on; a 24V voltage reaches the fourth output resistor RW1 by means of the base bright white light string LEDC1 and is then connected to the ground by means of the second triode Q4 to form a loop, a current passes through the compound semiconductors (i.e., lamp beads), and by means of the combination of electrons and holes, surplus energy is released in the form of light to fulfill a light-emitting effect, and at this moment, bright white light is emitted; when the OUTG pin is at a high level, the emitter and the base of the triode are connected by means of the resistor R8, the base of the triode is at a high level, and at this moment, the second triode Q4 is not turned on; the 24V voltage reaches the fourth output resistor RW1 by means of the base bright white light string LEDC1 and will not be connected to the ground by means of the second triode Q4, such that a loop will not be formed, and the bright white light is cut off.

The above embodiments are merely preferred ones of the disclosure and are not intended to limit the patent scope of the disclosure. All equivalent structures or flow transformations made according to the contents in the specification and accompanying drawings of the disclosure, or direct or indirect applications to other related technical fields should also fall within the patent protection scope of the disclosure.

What is claimed is:

1. An independent and separate control circuit, comprising a first control chip, a second control chip, a first MOS transistor, a second MOS transistor, a third MOS transistor, a fourth MOS transistor, a first triode, a second triode, a main lamp body bright white light string, a main lamp body warm white light string, a base bright white light string and a base warm white light string;
wherein, an OUTR pin of the first control chip is accessed to a power supply by means of a second resistor and connected to a gate of the first MOS transistor, a drain of the first MOS transistor is accessed to a 5V power supply by means of a first resistor and connected to a gate of the second MOS transistor, a drain of the second MOS transistor is connected to the main lamp body warm white light string by means of a first output resistor, an OUTG pin of the first control chip is accessed to a power supply by means of a third resistor and connected to a gate of the third MOS transistor, a drain of the third MOS transistor is accessed to a 5V power supply by means of a fourth resistor and connected to a gate of the fourth MOS transistor, a drain of the fourth MOS transistor is connected to the main lamp body bright white light string by means of a second output resistor, and a source of the first MOS transistor, a source of the second MOS transistor, a source of the third MOS transistor and a source of the fourth MOS transistor are grounded;
an OUTR pin of the second control chip is connected to a base of the first triode diode by means of a fifth resistor, the base of the first triode is connected to an emitter of the first triode by means of a sixth resistor, the emitter of the first triode is connected to the base warm white light string by means of a third output resistor, an OUTG pin of the second control chip is connected to a base of the second triode by means of a seventh resistor, the base of the second triode is connected to an emitter of the second triode by means of an eight resistor, the emitter of the second triode is connected to the base bright white light string by means of a fourth output resistor, and a collector of the first triode and a collector of the second triode are grounded.
